(19) United States
(12) Patent Application Publication
(10) Pub. No.: US 2025/0335248 A1
(43) Pub. Date: Oct. 30, 2025

(54) RESTRICTION OF BANDWIDTH UTILISATION

(71) Applicant: Arm Limited, Cambridge (GB)

(72) Inventors: Matteo Maria ANDREOZZI, Cambridge (GB); Klas Magnus BRUCE, Leander, TX (US); Peter Owen HAWKINS, Cambridge (GB)

(21) Appl. No.: 18/647,164

(22) Filed: Apr. 26, 2024

(51) Int. Cl. G06F 9/50

(52) U.S. Cl. CPC G06F 9/5016; G06F 9/5033; G06F 9/5044

(57) ABSTRACT

There is provided an apparatus, a method, and a computer program. The apparatus comprises a requesting processing element to issue a storage transaction in response to an access request from a process running on the requesting processing element, the process associated with an identifier. The apparatus is also provided with regulation circuitry to control bandwidth available to storage transactions requested by processes associated with the identifier. The regulation circuitry is configured to control the bandwidth, based on a transaction feedback signal issued by circuitry other than the requesting processing element and indicative of a resource utilisation parameter: when the resource utilisation parameter satisfies a resource utilisation condition, to apply a control to restrict the utilisation to a predefined limit assigned to the identifier; and when the resource utilisation parameter does not satisfy the resource utilisation condition, to apply a modification to the control based on the resource utilisation parameter.

### TECHNICAL FIELD

The present invention relates to data processing. More particularly the present invention relates to an apparatus, a method, and a computer program.

### BACKGROUND

Storage transactions requested by processes running on processing elements utilise bandwidth. Some processes may require high bandwidth utilisation which may result in a reduced bandwidth availability for other processes attempting to issue storage requests.

### SUMMARY

According to some examples of the present techniques there is provided an apparatus comprising:
a requesting processing element configured to issue a storage transaction in response to a storage access request from a process running on the requesting processing element, the process associated with an identifier; and
regulation circuitry configured to control a bandwidth utilisation available to storage transactions requested by processes associated with the identifier, wherein when operating in at least one mode the regulation circuitry is configured to control the bandwidth utilisation, based on a transaction feedback signal issued by circuitry other than the requesting processing element and indicative of a resource utilisation parameter:
   when the resource utilisation parameter satisfies a resource utilisation condition, to apply a control to restrict the bandwidth utilisation to a predefined limit assigned to the identifier; and
   when the resource utilisation parameter does not satisfy the resource utilisation condition, to apply a modification to the control based on the resource utilisation parameter.

According to some examples of the present techniques there is provided a method comprising:
with a requesting processing element, issuing a storage transaction in response to a storage access request from a process running on the requesting processing element, the process associated with an identifier; and
controlling a bandwidth utilisation available to storage transactions requested by processes associated with the identifier, wherein when operating in at least one mode the regulation comprises controlling the bandwidth utilisation, based on a transaction feedback signal issued by circuitry other than the requesting processing element and indicative of a resource utilisation parameter:
   when the resource utilisation parameter satisfies a resource utilisation condition, to apply a control to restrict the bandwidth utilisation to a predefined limit assigned to the identifier; and
   when the resource utilisation parameter does not satisfy the resource utilisation condition, to apply a modification to the control based on the resource utilisation parameter.

According to some examples of the present techniques there is provided a computer program for controlling a host data processing apparatus to provide an instruction execution environment, the computer program comprising:
requesting processing element program logic configured to issue a storage transaction in response to a storage access request from a process running on the requesting processing element program logic, the process associated with an identifier; and
regulation program logic configured to control a bandwidth utilisation available to storage transactions requested by processes associated with the identifier, wherein when operating in at least one mode the regulation program logic is configured to control the bandwidth utilisation, based on a transaction feedback signal issued by program logic other than the requesting processing element program logic and indicative of a resource utilisation parameter:
   when the resource utilisation parameter satisfies a resource utilisation condition, to apply a control to restrict the bandwidth utilisation to a predefined limit assigned to the identifier; and
   when the resource utilisation parameter does not satisfy the resource utilisation condition, to apply a modification to the control based on the resource utilisation parameter.

According to some configurations of the present techniques the computer program is stored on a computer readable storage medium.

According to some configurations of the present techniques the computer readable storage medium is a non-transitory computer readable storage medium.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates a memory system according to some configurations of the present techniques;

FIG. 4 schematically illustrates an apparatus according to some configurations of the present techniques;

FIG. 5 shows an example of different software execution environments executed by the processing circuitry;

FIG. 6 illustrates an example of allocating partition identifiers to different software execution environments;

FIG. 7 shows an example of control registers for controlling which partition identifier is specified for a given memory transaction;

FIG. 8 schematically illustrates an apparatus according to some configurations of the present techniques;

FIG. 9 schematically illustrates a sequence of steps carried out according to some configurations of the present techniques;

FIG. 10 schematically illustrates an apparatus according to some configurations of the present techniques;

FIG. 11 schematically illustrates a sequence of steps carried out according to some configurations of the present techniques;

FIG. 12 schematically illustrates an apparatus according to some configurations of the present techniques;

FIG. 13 schematically illustrates a sequence of steps carried out according to some configurations of the present techniques; and

FIG. 14 schematically illustrates a simulator implementation according to some configurations of the present techniques.

### DESCRIPTION OF EXAMPLE CONFIGURATIONS

Before discussing the configurations with reference to the accompanying figures, the following description of configurations is provided.

According to some configurations of the present techniques there is provided an apparatus comprising a requesting processing element configured to issue a storage transaction in response to a storage access request from a process running on the requesting processing element, the process associated with an identifier. The apparatus is also provided with regulation circuitry configured to control a bandwidth utilisation available to storage transactions requested by processes associated with the identifier. When operating in at least one mode the regulation circuitry is configured to control the bandwidth utilisation, based on a transaction feedback signal issued by circuitry other than the requesting processing element and indicative of a resource utilisation parameter: when the resource utilisation parameter satisfies a resource utilisation condition, to apply a control to restrict the bandwidth utilisation to a predefined limit assigned to the identifier; and when the resource utilisation parameter does not satisfy the resource utilisation condition, to apply a modification to the control based on the resource utilisation parameter.

The control of bandwidth utilisation by processes based on identifiers assigned to those processes can be used to prevent processes assigned to a particular identifier from monopolising bandwidth availability and, in some cases, preventing other processes from being able to issue transactions requiring bandwidth in a timely manner. The control can be achieved through the assignment of a predefined limit to the identifier that, for example, can be used to restrict a maximum bandwidth utilisation of processes associated with the identifier, or a minimum bandwidth utilisation that is provided to processes associated with the identifier. The identifiers associated with the processes and, hence, the transaction requests issued by or on behalf of those processes are therefore used to control the bandwidth availability and are not necessarily indicative of regions of memory that can or cannot be accessed by a given process.

The inventors have recognised that the restriction of bandwidth utilisation based on a predefined limit assigned to an identifier may, in some use cases, result in either underutilisation of a total available bandwidth, or overutilisation of the available bandwidth by some processes. In particular, where the bandwidth utilisation is controlled on the level of a processing element, that processing element may not have a complete picture of all bandwidth utilisation in the apparatus either by processes associated with the identifier or other processes that are associated with a different identifier. The regulation circuitry is therefore provided with at least one mode of operation (which may, in some configurations, be the only mode of operation or, in other configurations, one of a plurality of modes of operation) in which the implementation of the control is dependent on a feedback signal that is provided from circuitry other than the requesting processing element. In other words, the control of the transaction requests by the requesting processing element may be modified (e.g., changed or influenced) by one or more other circuits within the apparatus. The feedback signal includes a resource utilisation parameter which is indicative of resource usage in the apparatus. Dependent on whether the resource utilisation parameter meets a resource utilisation condition, the regulation circuitry may perform the control specified by the predefined limit (i.e., when the resource utilisation condition is met) or may make a modification to the control (i.e., when the resource utilisation condition is not met). The control applied when the resource utilisation condition is not met is therefore control other than or in addition to the restriction of the bandwidth utilisation to the predefined limit assigned to the identifier. The use of the transaction feedback signal to modify control based on resource utilisation allows the regulation circuitry to ensure that under certain system conditions (when the resource utilisation condition is met) the predefined limits are applied and processes are able to receive a fair share (as defined by the predefined limits) of the bandwidth availability. In addition, the regulation circuitry is able to adapt these limits to improve bandwidth utilisation due to conditions in the apparatus that are outside of or otherwise unknown to the processing element. As a result, the overall throughput of transactions can be improved resulting in an increased processing efficiency.

The resource utilisation parameter may relate to general resource utilisation, e.g., due to processes associated with one or more different identifiers. However, in some configurations the resource utilisation parameter indicates utilisation of resources by processes associated with the identifier. The resource utilisation parameter may therefore provide an indication of actual resource utilisation by the process based on one or more parameters of the memory system or other processing elements running processes associated with the identifier.

In some configurations the resource utilisation parameter comprises an indication of utilisation of resources other than the requesting processing element. The resource utilisation parameter may include a global resource usage characteristic indicating the utilisation of all resources including the requesting processing element and the resources other than the requesting processing element. Alternatively, the resource utilisation parameter may include resource specific utilisation characteristics indicative of the specific utilisation of one or more other resources.

In some configurations the resource utilisation parameter comprises processing element identifying information indicative of processing elements running processes associated with the identifier, and the resource utilisation condition comprises a processing element condition satisfied when the requesting processing element is the only processing element identified as running processes associated with the identifier. The processing element condition is therefore not satisfied if multiple processing elements are identified as running processes associated with the identifier. Where the requesting processing element is the only processing element running processes that are associated with the identifier, the predetermined limit can be interpreted as limiting the bandwidth utilisation of that process running on that processing element. When multiple processing elements are identified as running processes associated with the identifier, then if each of the processing elements were to be assigned the predefined limit the total bandwidth that could theoretically be utilised by processes assigned to the identifier would be the predefined limit multiplied by the number of processing elements running those processes. As a result, the processes assigned to the identifier would be able to obtain a bandwidth utilisation much greater than the limit assigned to those processes. Hence, modification of the control based on the resource utilisation parameter allows a fair share policy to be implemented where it is not known a-priori how many processing elements will be running processes assigned to the identifier. Furthermore, where the number of processing elements running processes assigned to the identifier dynamically changes during runtime, the regulation circuitry can respond to this information, as identified in the feedback signal, and can adapt the limitations applied to the requesting processing element.

Whilst the processing element identification information could take any form, e.g., a single bit indicating whether one or plural processing elements are running processes associated with the identifier, in some configurations the processing element identifying information indicates a number of processing elements running processes associated with the identifier, and the modification comprises restricting the bandwidth utilisation to a reduced limit based on the number of processing elements. The reduced limit may be updated during runtime based on the number of processing elements and may further be varied based on one or more other conditions comprised in the resource utilisation parameter.

In some configurations the reduced limit is calculated by dividing the bandwidth utilisation limit by the number of processing elements running processes associated with the identifier. The division may be a strict mathematical division in which the limit is calculated as A/B where A is equal to the bandwidth utilisation limit and B is equal to the number of processing elements. Alternatively, the division may comprise a sharing of the bandwidth between the processing elements. For example, the resource utilisation parameter may indicate the number of processing elements and an indication of a bandwidth utilisation fraction indicating the fraction of the total bandwidth utilisation for the identifier that is associated with each processing element. In such a configuration, the reduced limit could be split based on the fraction for each processing element. In some configurations the division may be an approximate division. For example, the number of processing elements B may be rounded to a nearest power of 2 to allow the division to be calculated using shifting circuitry. In other words, B is rounded to 2^{P} and the reduced limit is calculated by right shifting the bandwidth utilisation limit A by P places. This approach avoids the need for a full division to be calculated whilst producing an approximate reduced limit suitable for bandwidth utilisation control.

In some configurations the apparatus comprises interconnect circuitry configured to store processing element utilisation information indicative of a number of processing elements issuing transaction requests associated with the identifier, wherein the interconnect is configured to issue the feedback signal indicating the number of processing elements. When issuing a transaction, the processing element may associate the identifier with the transaction along with an indication of the processing element that is requesting the transaction. The inclusion of the identifier may allow one or more circuits receiving the transaction to implement their own fair share policies in relation to the identifier and can be exploited by the interconnect circuitry to track which processing elements are running processes assigned to the identifier. The processing element utilisation information may comprise a bitmap storing an indication of each processing element for which a transaction request having the identifier has been issued. The bit map may be stored in a set associative storage structure indexed based on the identifier and having entries identifying, for each processing element of the apparatus, whether that processing element has issued a transaction request associated with the identifier.

In some configurations the interconnect is configured to apply an aging mechanism to the processing element utilisation information. For example, the aging mechanism may comprise recording, each time a transaction is received associated with the identifier, information indicative of a timestamp indicated by a repeating counter. The information may then be invalidated once the counter has looped once round and arrived at the same value as the stored timestamp.

In some configurations the aging mechanism comprises storing the processing element utilisation information over a sliding window. Where a transaction indicating the identifier is received from a processing element within the sliding window, that indication may be stored by the interconnect circuitry to indicate that the processing element is actively running a process associated with the identifier. Where no transactions indicating the identifier are received from the processing element during the sliding window, any indications stored in the interconnect circuitry may be zeroed. It will be readily apparent to the skilled person that alternative aging mechanisms may be applied to the processing element utilisation information.

In some configurations the resource utilisation parameter comprises a congestion parameter indicative of congestion of storage requests and the resource utilisation condition comprises a congestion condition satisfied when the congestion parameter exceeds a congestion threshold. The congestion parameter may be included in the resource utilisation parameter in addition to the processing element utilisation information or as an alternative to the processing element utilisation information discussed above. The congestion parameter may be an existing parameter provided from a storage system to indicate an overall utilisation of storage buffers. For example, the congestion parameter may comprise a multi-bit signal indicating a congestion level of the storage system, e.g., not congested, lightly congested, or heavily congested. The congestion threshold may be exceeded when the congestion parameter indicates anything other than not congested. Alternatively, the congestion threshold may only be exceeded when the congestion parameter indicates heavy congestion.

In some configurations the restriction circuitry is configured, when applying the modification, to allow the processing element to issue requests at a rate greater than the predefined limit. For example, when the congestion parameter indicates that the congestion level is low (e.g., not congested), the regulation circuitry may allow the predefined limit to be exceeded based on the knowledge that there is still sufficient bandwidth available (due to the low level of congestion) for transactions issued in relation to processes associated with one or more other identifiers.

Whilst allowing the processing element to issue requests at a rate greater than the predefined limit may comprise allowing the processing element to issue requests in an unrestricted manner, in some configurations the restriction circuitry is configured, when applying the modification, to apply a soft limit to the bandwidth utilisation, the soft limit allowing the bandwidth utilisation to exceed the predefined limit. The soft limit may be a limit specified by software and editable on a per-identifier basis. Alternatively, the soft limit may be specified as a global percentage increase that can be applied to the predefined limit. In some configurations, multiple soft limits may be provided and may each be applied based on a different level of congestion. For example, the predefined limit may be applied when the congestion is high, a first soft limit may be applied when the congestion is low, and a second soft limit (allowing a greater bandwidth utilisation than the first soft limit) may be applied when there is no congestion identified by the resource utilisation parameter.

In some configurations the utilisation parameter is issued by a storage hierarchy. The resource utilisation parameter may be issued by one or more levels of storage in the storage hierarchy. For example, the resource utilisation parameter may be issued by one or more levels of cache and/or from a main system memory, e.g., DRAM.

In some configurations the apparatus comprises one or more software accessible registers, wherein the predefined limit is stored in the one or more registers. The software accessible register may be a software configurable register that is configurable by software operating at one or more different privilege levels. For example, the software accessible register may be configurable by software with a privilege level greater than a threshold privilege level.

In some configurations the identifier is one of a plurality of identifiers, each assignable to one or more processes and the predefined limit is set on a per identifier basis. The predefined limit may be set as part of an architectural state associated with a currently executing process and may be loaded into the one or more software accessible registers as part of the execution of the process. When the processor executes a context switch from a current process to a different process, which may be associated with a different identifier, the predefined limit associated with the different identifier may be loaded in place of the predefined limit associated with the current process.

Whilst the at least one mode may be the only mode that the regulation circuitry is able to operate in, in some configurations the requesting processing element is operable in a further mode in which the regulation circuitry is configured to restrict the bandwidth utilisation to the predefined limit independent of the transaction feedback signal. In other words, the regulation circuitry is able to operate in a mode in which the predefined limit associated with the identifier is strictly enforced for the requesting processing element independent of the feedback signal. The mode of operation may be controllable by software operating at a higher privilege level, for example, a hypervisor or an operating system may be assigned a sufficiently high privilege level to be able to control the mode of operation.

In some configurations the requesting processing element is configured to stall execution of the process in response to the one or more limits being met. In some configurations the processing element may respond to the stall by performing a context switch to a different process having a different identifier, e.g., an identifier that has not hit the predefined limit associated with that identifier. Alternatively, the processing element may remain in a stalled state until the regulation circuitry identifies that either the bandwidth utilisation associated with the identifier has dropped, or the regulation circuitry modifies the control (e.g., due to a change in the resource utilisation parameter) such that transaction requests may still be issued by (or on behalf of) the processing element.

In some configurations the identifier associated with the process is defined in a software-configurable register. The software-configurable register may be a dedicated register configured to store the identifier or may be a shared register that also shares information identifying the predefined limit. The software-configurable register may be configurable by software having a privilege level greater than a threshold privilege level. For example, the software-configurable register may be configurable by a hypervisor or an operating system operating at a higher privilege level than user applications.

Particular configurations will now be described with reference to the figures.

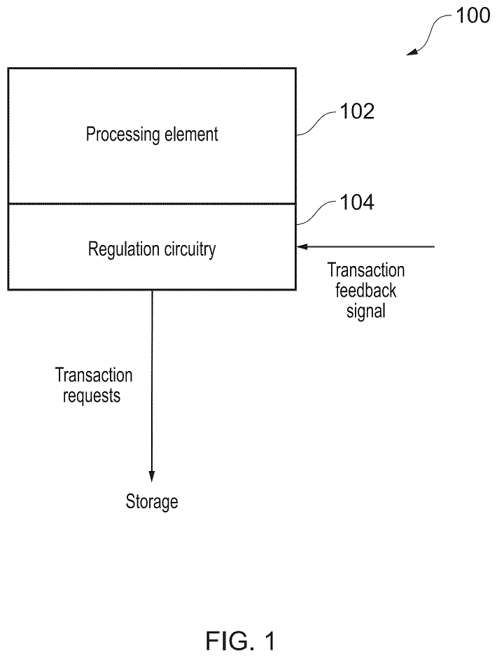

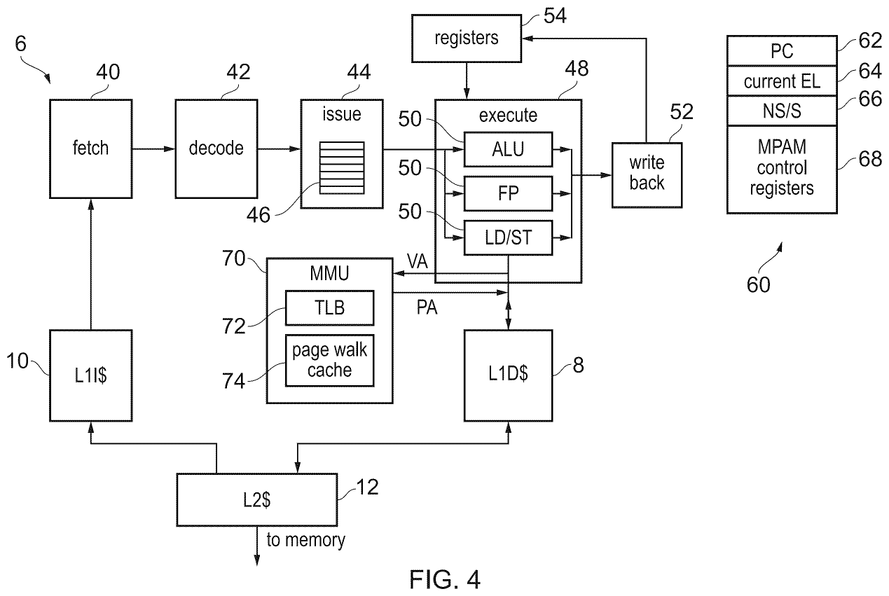

FIG. 1 illustrates an apparatus 100 according to some configurations of the present techniques. The apparatus 100 comprises a processing element 102 and regulation circuitry 104. The processing element comprises processing circuitry, for example, as described in relation to FIG. 4 below and is configured to perform a sequence of operations associated with a process. The process is defined by an identifier. The processing element 102 is responsive to some types of instructions, for example, load instructions and store instructions to trigger a transaction request to be issued to storage circuitry. The regulation circuitry 104 is configured to control bandwidth utilisation that is available to the transactions requested by the processing element 102 based on the identifier assigned to the process that is executing on the processing element 102. The control is based on a transaction feedback signal that is received from circuitry other than the processing element 102. The transaction feedback signal indicates a resource utilisation parameter indicative of a resource utilisation. The regulation circuitry 104 determines whether the transaction feedback signal satisfies a resource utilisation condition. When the regulation circuitry 104 determines that the resource utilisation condition is satisfied, the regulation circuitry 104 restricts the bandwidth utilisation of the processing element 102 to a predefined limit that is associated with the identifier assigned to the process. When the regulation circuitry 104 determines that the resource utilisation condition is not satisfied, the regulation circuitry 104 applies a modification to the control, the modification is based on the resource utilisation parameter.

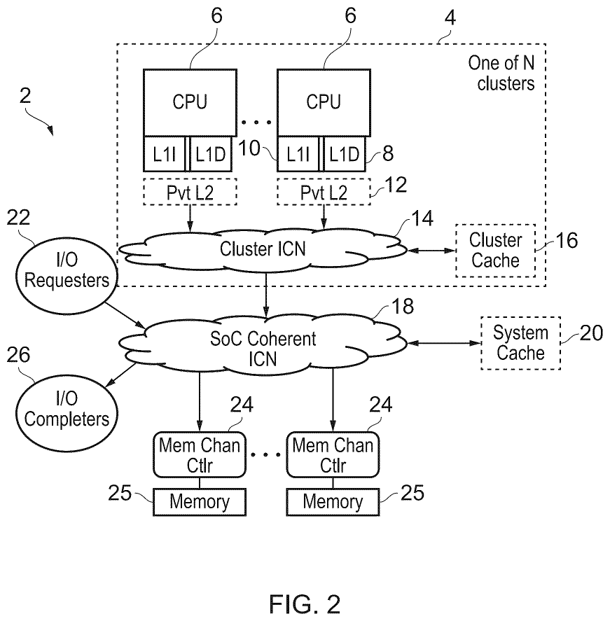

FIG. 2 schematically illustrates an example of an apparatus 2 according to some configurations of the present techniques. The apparatus 2 comprises N processing clusters 4 (N is 1 or more), where each processing cluster includes one or more processing elements 6 such as a CPU (central processing unit) or GPU (graphics processing unit). Each processing element 6 may have at least one cache, e.g. a level 1 data cache 8, level 1 instruction cache 10 and shared level 2 cache 12. It will be appreciated that this is just one example of a possible cache hierarchy and other cache arrangements could be used. The processing elements 6 within the same cluster are coupled by a cluster interconnect 14. The cluster interconnect 14 may have a cluster cache 16 for caching data accessible to any of the processing elements.

A system on chip (SoC) interconnect 18 couples the N clusters and any other requester devices 22 (such as display controllers or direct memory access (DMA) controllers). The SoC interconnect may have a system cache 20 for caching data accessible to any of the requesters connected to it. The SoC interconnect 18 controls coherency between the respective caches 8, 10, 12, 16, 20 according to any known coherency protocol. The SoC interconnect is also coupled to one or more memory controllers 24, each for controlling access to a corresponding memory 25, such as DRAM or SRAM. The SoC interconnect 18 may also direct transactions to other completer devices, such as a crypto unit for providing encryption/decryption functionality.

Hence, the data processing system 2 comprises a memory system for storing data and providing access to the data in response to transactions issued by the processing elements 6 and other requester devices 22. The caches 8, 10, 12, 16, 20, the interconnects 14, 18, memory controllers 24 and memory devices 25 can each be regarded as a component of the memory system. Other examples of memory system components may include memory management units or translation lookaside buffers (either within the processing elements 6 themselves or further down within the system interconnect 18 or another part of the memory system), which are used for translating memory addresses used to access memory, and so can also be regarded as part of the memory system. In general, a memory system component may comprise any component of a data processing system used for servicing memory transactions for accessing memory data or controlling the processing of those memory transactions.

The memory system may have various resources available for handling memory transactions. For example, the caches 8, 10, 12, 16, 20 have storage capacity available for caching data required by a given software execution environment executing on one of the processing elements 6, to provide quicker access to data or instructions than if they had to be fetched from main memory 25. Similarly, MMUs/TLBs may have capacity available for caching address translation data. Also, the interconnects 14, 18, the memory controller 24 and the memory devices 25 may each have a certain amount of bandwidth available for handling memory transactions.

When multiple software execution environments executing on the processing elements 6 share access to the memory system, it can be desirable to prevent one software execution environment using more than its fair share of resource, to prevent other execution environments perceiving a loss of performance. This can be particularly important for data centre (server) applications where there is an increasing demand to reduce capital expenditure by increasing the number of independent software processes which interact with a given amount of memory capacity, to increase utilisation of the data centre servers. Nevertheless, there will still be a demand to meet web application tail latency objectives and so it is undesirable if one process running on the server can monopolise memory system resources to an extent that other processes suffer. Similarly, for networking applications, it is increasingly common to combine multiple functions onto a single SoC which previously would have been on separate SoCs. This again leads to a desire to limit performance interactions between software execution environments, and to monitor how those need to allow those independent processes to access the shared memory while limiting performance interactions.

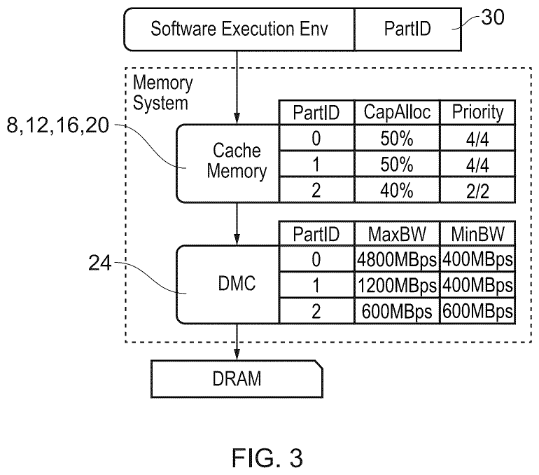

FIG. 3 schematically illustrates an example of partitioning the control of allocation of memory system resources in dependence on the software execution environment which issues the corresponding memory transactions. In this context, a software execution environment may be any process, or part of a process, executed by a processing element within a data processing system. For example, a software execution environment may comprise an application, a guest operating system or virtual machine, a host operating system or hypervisor, a security monitor program for managing different security states of the system, or a sub-portion of any of these types of processes (e.g. a single virtual machine may have different parts considered as separate software execution environments). As shown in FIG. 3, each software execution environment may be allocated a given partition identifier (PartID) 30 which is passed to the memory system components along with memory transactions that are associated with that software execution environment. The partition identifier is an example of an identifier.

Within the memory system component, resource allocation or contention resolution operations can be controlled based on one of a number of sets of memory system component parameters selected based on the partition identifier. For example, as shown in FIG. 3, each software execution environment may be assigned an allocation threshold (an example of a predefined limit) representing a maximum amount of cache capacity that can be allocated for data/instructions associated with that software execution environment, with the relevant allocation threshold when servicing a given transaction being selected based on the partition identifier associated with the transaction. For example, in FIG. 3 transactions associated with partition identifier 0 may allocate data to up to 50% of the cache's storage capacity, leaving at least 50% of the cache available for other purposes.

Similarly, in a memory system component such as the memory controller 24 which has a finite amount of bandwidth available for servicing memory transactions, minimum and/or maximum bandwidth thresholds may be specified for each partition identifier. A memory transaction associated with a given partition identifier can be prioritised if, within a given period of time, memory transactions specifying that partition identifier have used less than the minimum amount of bandwidth, while a reduced priority can be used for a memory transaction if the maximum bandwidth has already been used or exceeded for transactions specifying the same partition identifier.

These control schemes will be discussed in more detail below. It will be appreciated that these are just two examples of ways in which control of memory system resources can be partitioned based on the software execution environment that issued the corresponding transactions. In general, by allowing different processes to “see” different partitioned portions of the resources provided by the memory system, this allows performance interactions between the processes to be limited to help address the problems discussed above.

Similarly, the partition identifier associated with memory transactions can be used to partition performance monitoring within the memory system, so that separate sets of performance monitoring data can be tracked for each partition identifier, to allow information specific to a given software execution environment (or group of software execution environments) to be identified so that the source of potential performance interactions can be identified more easily than if performance monitoring data was recorded across all software execution environments as a whole. This can also help diagnose potential performance interaction effects and help with identification of possible solutions.

An architecture is discussed below for controlling the setting of partition identifiers, labelling of memory transactions based on the partition identifier set for a corresponding software execution environment, routing the partition identifiers through the memory system, and providing partition-based controls at a memory system component in the memory system. This architecture is scalable to a wide range of uses for the partition identifiers. The use of the partition identifiers is intended to layer over the existing architectural semantics of the memory system without changing them, and so addressing, coherence and any required ordering of memory transactions imposed by the particular memory protocol being used by the memory system would not be affected by the resource/performance monitoring partitioning. When controlling resource allocation using the partition identifiers, while this may affect the performance achieved when servicing memory transactions for a given software execution environment, it does not affect the result of an architecturally valid computation. That is, the partition identifier does not change the outcome or result of the memory transaction (e.g. what data is accessed), but merely affects the timing or performance achieved for that memory transaction.

FIG. 4 schematically illustrates an example of the processing element 6 in more detail. The processor includes a processing pipeline including a number of pipeline stages, including a fetch stage 40 for fetching instructions from the instruction cache 10, a decode stage 42 for decoding the fetched instructions, an issue stage 44 comprising an issue queue 46 for queueing instructions while waiting for their operands to become available and issuing the instructions for execution when the operands are available, an execute stage 48 comprising a number of execute units 50 for executing different classes of instructions to perform corresponding processing operations, and a write back stage 52 for writing results of the processing operations to data registers 54. Source operands for the data processing operations may be read from the registers 54 by the execution stage 48. In this example, the execute stage 48 includes an ALU (arithmetic/logic unit) for performing arithmetic or logical operations, a floating point (FP) unit for performing operations using floating-point values and a load/store unit for performing load operations to load data from the memory system into registers 54 or store operations to store data from registers 54 to the memory system. It will be appreciated that these are just some examples of possible execution units and other types could be provided. Similarly, other examples may have different configurations of pipeline stages. For example, in an out-of-order processor, an additional register renaming stage may be provided for remapping architectural register specifiers specified by instructions to physical register specifiers identifying registers 54 provided in hardware, as well as a reorder buffer for tracking the execution and commitment of instructions executed in a different order to the order in which they were fetched from the cache 10. Similarly, other mechanisms not shown in FIG. 4 could still be provided, e.g. branch prediction functionality.

The processing element 6 has a number of control registers 60, including for example a program counter register 62 for storing a program counter indicating a current point of execution of the program being executed, an exception level register 64 for storing an indication of a current exception level at which the processor is executing instructions, a security state register 66 for storing an indication of whether the processing element 6 is in a non-secure or a secure state, and memory partitioning and monitoring (MPAM) control registers 68 for controlling memory system resource and performance monitoring partitioning (the MPAM control registers are discussed in more detail below). It will be appreciated that other control registers could also be provided.

The processing element 6 has a memory management unit (MMU) 70 for controlling access to the memory system in response to memory transactions. For example, when encountering a load or store instruction, the load/store unit issues a corresponding memory transaction specifying a virtual address. The virtual address is provided to the memory management unit (MMU) 70 which translates the virtual address into a physical address using address mapping data stored in a translation lookaside buffer (TLB) 72. Each TLB entry may identify not only the mapping data identifying how to translate the address, but also associated access permission data which defines whether the processor is allowed to read or write to addresses in the corresponding page of the address space. In some examples there may be multiple stages of address translation and so there may be multiple TLBs, for example a stage 1 TLB providing a first stage of translation for mapping the virtual address generated by the load/store unit 50 to an intermediate physical address, and a stage 2 TLB providing a second stage of translation for mapping the intermediate physical address to a physical address used by the memory system to identify the data to be accessed. The mapping data for the stage 1 TLB may be set under control of an operating system, while the mapping data for the stage 2 TLB may be set under control of a hypervisor, for example, to support virtualisation. While, for conciseness, FIG. 4 shows the MMU being accessed in response to data accesses being triggered by the load/store unit, the MMU may also be accessed when the fetch stage 40 requires fetching of an instruction which is not already stored in the instruction cache 10, or if the instruction cache 10 initiates an instruction prefetch operation to prefetch an instruction into the cache before it is actually required by the fetch stage 40. Hence, virtual addresses of instructions to be executed may similarly be translated into physical addresses using the MMU 70.

In addition to the TLB 72, the MMU may also comprise other types of cache, such as a page walk cache 74 for caching data used for identifying mapping data to be loaded into the TLB during a page table walk. The memory system may store page tables specifying address mapping data for each page of a virtual memory address space. The TLB 72 may cache a subset of those page table entries for a number of recently accessed pages. If the processing element 6 issues a memory transaction to a page which does not have corresponding address mapping data stored in the TLB 72, then a page table walk is initiated. This can be relatively slow because there may be multiple levels of page tables to traverse in memory to identify the address mapping entry for the required page. To speed up page table walks, recently accessed page table entries of the page table can be placed in the page walk cache 74. These would typically be page table entries other than the final level page table entry which actually specifies the mapping for the required page. These higher level page table entries would typically specify where other page table entries for corresponding ranges of addresses can be found in memory. By caching at least some levels of the page table traversed in a previous page table walk in the page walk cache 74, page table walks for other addresses sharing the same initial part of the page table walk can be made faster. Alternatively, rather than caching the page table entries themselves, the page walk cache 74 could cache the addresses at which those page table entries can be found in the memory, so that again a given page table entry can be accessed faster than if those addresses had to be identified by first accessing other page table entries in the memory.

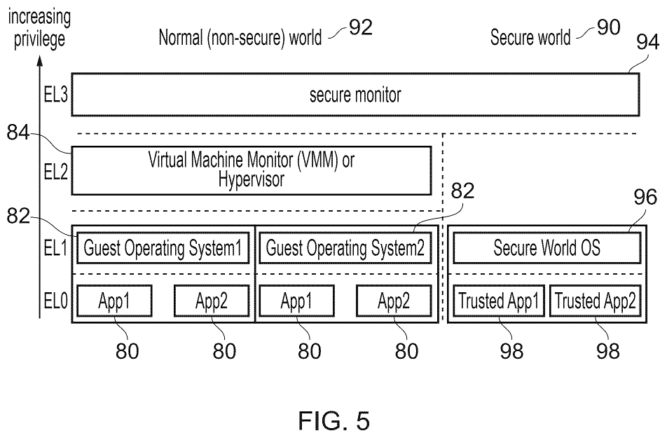

FIG. 5 shows an example of different software execution environments which may be executed by the processing element 6. In this example the architecture supports four different exception levels EL0 to EL3 increasing in privilege level (so that EL3 has the highest privilege exception level and EL0 has the lowest privilege exception level). In general, a higher privilege level has greater privilege than a lower privilege level and so can access at least some data and/or carry out some processing operations which are not available to a lower privilege level. Applications 80 are executed at the lowest privilege level EL0. A number of guest operating systems 82 are executed at privilege level EL1 with each guest operating system 82 managing one or more of the applications 80 at EL0. A virtual machine monitor, also known as a hypervisor or a host operating system, 84 is executed at exception level EL2 and manages the virtualisation of the respective guest operating systems 82. Transitions from a lower exception level to a higher exception level may be caused by exception events (e.g. events required to be handled by the hypervisor may cause a transition to EL2), while transitions back to a lower level may be caused by return from handling an exception event. Some types of exception events may be serviced at the same exception level as the level they are taken from, while others may trigger a transition to a higher exception state. The current exception level register 64 indicates which of the exception levels EL0 to EL3 the processing element 6 is currently executing code in.

In this example the system also supports partitioning between a secure domain 90 and a normal (less secure) domain 92. Sensitive data or instructions can be protected by allocating them to memory addresses marked as accessible to the secure domain 90 only, with the processor having hardware mechanisms for ensuring that processes executing in the less secure domain 92 cannot access the data or instructions. For example, the access permissions set in the MMU 70 may control the partitioning between the secure and non-secure domains, or alternatively a completely separate security memory management unit may be used to control the security state partitioning, with separate secure and non-secure MMUs 70 being provided for sub-control within the respective security states. Transitions between the secure and normal domains 90, 92 may be managed by a secure monitor process 94 executing at the highest privilege level EL3. This allows transitions between domains to be tightly controlled to prevent non-secure operations 80 or operating systems 82 for example accessing data from the secure domain. In other examples, hardware techniques may be used to enforce separation between the security states and police transitions, so that it is possible for code in the normal domain 92 to branch directly to code in the secure domain 90 without transitioning via a separate secure monitor process 94. However, for ease of explanation, the subsequent description below will refer to an example which does use the secure monitor process 94 at EL3. Within the secure domain 90, a secure world operating system 96 executes at exception level EL1 and one or more trusted applications 98 may execute under control of that operating system 96 at exception level EL0. In this example there is no exception level EL2 in the secure domain 90 because virtualisation is not supported in the secure domain, although it would still be possible to provide this if desired. An example of an architecture for supporting such a secure domain 90 may be the Trustzone architecture provided by ARM® Limited of Cambridge, UK. Nevertheless, it will be appreciated that other techniques could also be used. Some examples could have more than two security states, providing three or more states with different levels of security associated with them. The security state register 66 indicates whether the current domain is the secure domain 90 or the non-secure 92 and this indicates to the MMU 70 or other control units what access permissions to use to govern whether certain data can be accessed or operations are allowed.

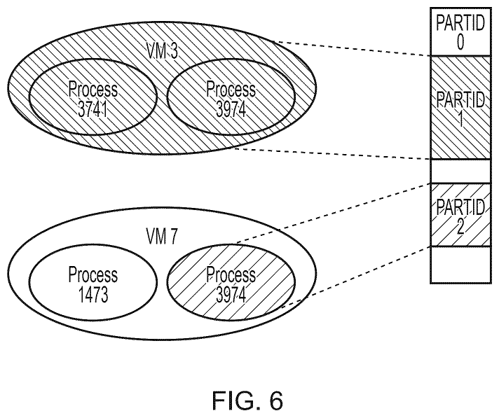

FIG. 5 shows a number of different software execution environments 80, 82, 84, 94, 96, 98 which can be executed on the system. Each of these software execution environments can be allocated a given partition identifier (partition ID or PARTID), or a group of two or more software execution environments may be allocated a common partition ID. In some cases, individual parts of a single processes (e.g. different functions or sub-routines) can be regarded as separate execution environments and allocated separate partition IDs. For example, FIG. 6 shows an example where virtual machine VM 3 and the two applications 3741, 3974 executing under it are all allocated PARTID 1, a particular process 3974 executing under a second virtual machine, VM 7, is allocated PARTID 2, and the VM7 itself and another process 1473 running under it is allocated PARTID 0. It is not necessary to allocate a bespoke partition ID to every software execution environment. A default partition ID may be specified to be used for software execution environments for which no dedicate partition ID has been allocated. The control of which parts of the partition ID space are allocated to each software execution environment is carried out by software at a higher privilege level, for example a hypervisor running at EL2 controls the allocation of partitions to virtual machine operating systems running at EL1. However, in some cases the hypervisor may permit an operating system at a lower privilege level to set its own partition IDs for parts of its own code or for the applications running under it. Also, in some examples the secure world 90 may have a completely separate partition ID space from the normal world 92, controlled by the secure world OS or monitor program EL3.

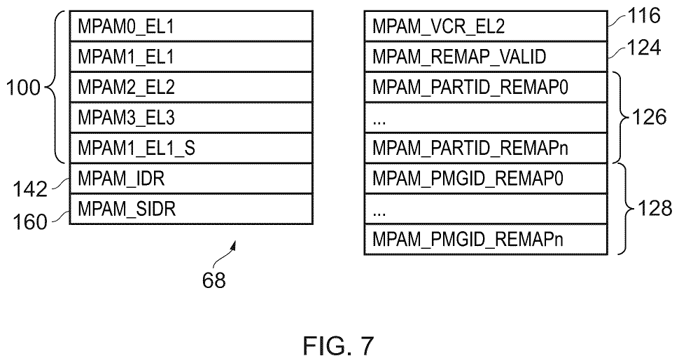

FIG. 7 shows an example of the MPAM control registers 68. The MPAM control registers 68 include a number of partition ID registers 100 (also known as MPAM system registers) each corresponding to a respective operating state of the processing circuitry. In this example the partition ID registers 100 include registers MPAM0_EL1 to MPAM3_EL3 corresponding the respective exception levels EL0 to EL3 in the non-secure domain 92, and an optional additional partition ID register MPAM1_EL1_S corresponding to exception level EL1 in the secure domain 90. In this example, there is no partition ID register provided for EL0 in the secure domain, as it is assumed that the trusted applications 98 in the secure domain are tied closely to the secure world operating system 96 that runs those applications 98 and so they can be identified with the same partition ID. However, in other implementations a separate partition ID register could be provided for EL0 in the secure world. Each partition ID register 100 comprises fields for up to three partition IDs as shown in table 1 below:

TABLE 1

| ID Name | Description |
|---|---|
| PARTID_D | Partition ID used for data requests. |
| PARTID_I | Partition ID used for instruction requests. |
| PMG | Performance monitoring group ID. |

Table 2 below summarises which partition ID register 100 is used for memory transactions executed in each operating state, and which operating states each partition ID register 100 are controlled from (that is, which operating state can update the information specified by that register):

TABLE 2

| Partition ID | Controlled | Controls IDs | Notes (explained in more |
|---|---|---|---|
| register 100 | From | When Executing In | detail below) |
| MPAM0_EL1 | NS_EL1 | NS_EL0 when | MPAM0 EL1 IDs can be |
| | | PLK_EL0 in | remapped with virtualization |
| | | MPAM1_EL1 = 0 | option. |
| | | (Applications) | Can be overridden by |
| | | | MPAM1 EL1 control bit, |
| | | | PLK_EL0. |
| MPAM1_EL1 | NS_EL2 | NS_EL1 | MPAM1_EL1 IDs can be |
| | NS_EL1 | (Guest OS) | remapped with virtualization |
| | | NS_EL0 when | option. |
| | | PLK_EL0 = 1 | Can override MPAM0_EL1. |
| | | | If NS_EL2 not implemented, |
| | | | MPAM1_EL1 is controlled by |
| | | | NS_EL1. |
| | | | If NS_EL2 is implemented, |
| | | | MPAM1_EL1 may be |
| | | | controlled from NS_EL2 if |
| | | | MPAM2_EL2.EL1_WRINH is |
| | | | 1, or from NS_EL2 and |
| | | | NS_EL1 if |
| | | | MPAM2_EL2.EL1_WRINH is |
| | | | 0. |
| MPAM2_EL2 | EL3 | NS_EL2 | If EL3 is not implemented or |
| | NS_EL2 | (Hypervisor) | MPAM secure option not |
| | | | implemented, MPAM2_EL2 is |
| | | | only controlled from NS_EL2. |
| MPAM1_EL1_S | EL3 | S_EL1 | MPAM1 EL1 S may be |
| (optional - if | S_EL1 | S_EL0 | controlled from EL3 if |
| not provided, | | (secure) | MPAM3_EL3.EL1_S_WRINH |
| MPAM1_EL1 | | | is 1, or from EL3 and S_EL1 |
| can be used for | | | if |
| controlling IDs | | | MPAM3_EL3.EL1_S_WRINH |
| in S_EL1 and | | | is 0. |
| S_EL0) | | | |
| MPAM3_EL3 | EL3 | EL3 | MPAM3_EL3 is controlled |
| | | | from EL3. |

The naming convention MPAMx_Ely for the partition ID registers indicates that the partition IDs specified in the partition ID register MPAMx_ELy are used for memory transactions issued by the processing circuitry 6 when in operating state ELx and that state ELy is the lowest exception level at which that partition ID register MPAMx_ELy can be accessed. However, when the current exception level is EL0 in the non-secure domain, MPAM0_EL1 can be overridden—when a configuration value PLK_EL0 set in MPAM-EL1 is set to 1 the partition IDs in MPAM1_EL1 are used when executing in NS_EL0. Hence, the control for EL1 can override the control for EL0 when desired. This can be useful for constraining all applications running under a particular virtual machine to use the same partition ID to avoid needing to update MPAM0_EL1 each time there is a context switch between applications within the same virtual machine. While the configuration parameter PLK_EL0 is described as being stored in MPAM1_EL1 in this example (the partition ID register corresponding to the higher exception level which sets that configuration parameter), it could also be stored in another control register.

In general, when switching between different processes executed at the same state (e.g. different applications at EL0 or different guest operating systems at EL1), an exception event triggers a switch to a higher exception state where the process running at that state (e.g. the operating system at EL1 or the hypervisor at EL2) then updates the partition IDs in the relevant partition ID register 100 before returning processing to the lower exception state to allow the new process to continue. Hence, the partition IDs associated with a given process may effectively be seen as part of the context information associated with that process, which is saved and restored as part of the architectural state of the processor when switching from or to that process.

However, by providing multiple partition ID registers 100 corresponding to the different operating states of the system, it is not necessary to update the contents of a single partition ID register each time there is a change in operating state at times other than at a context switch, such as when an operating system (OS) traps temporarily to the hypervisor for the hypervisor to carry out some action before returning to the same OS. Such traps to the hypervisor may be fairly common in a virtualised system, e.g. if the hypervisor has to step in to give the OS a different view of physical resources than what is actually provided in hardware. Hence, by providing multiple partition ID registers 100, labelling of memory system transactions with partition IDs automatically follows changes of the exception level or of the secure/non-secure state, so that there is faster performance as there is no need to update the partition IDs each time there is a change in exception level or security state.

Also, providing separate secure and less secure partition ID registers can be preferable for security reasons, by preventing a less secure process inferring information about the secure domain from the partition IDs used, for example. However, banking partition ID registers per security state is optional, and other embodiments may provide only a single version of a given partition ID register shared between the secure and less secure domains (e.g. MPAM1_EL1 can be used, with MPAM1_EL1_S being omitted). In this case, the monitor code executed at EL3 may context switch the information in the partition ID register when switching between the secure and less secure domains.

Also, in general the control information, such as the partition IDs and any associated configuration information, specified within the partition ID register 100 associated with a given operating state is set in response to instructions executing at a higher exception level than the exception level associated with that partition ID register 100. However, again this general premise can be overridden for some of the registers, where the higher exception level code may set a configuration parameter EL1_WRINH, EL2_WRINH or EL1_S_WRINH which controls whether code executing at a given operating state may set its own partition IDs in the corresponding partition ID register. That is, the WRINH configuration values specify whether a given execution environment is allowed to set the partition IDs allocated to itself. While the examples below show the WRINH flag for controlling setting of the partition IDs by a given exception level being stored in the partition ID register 100 associated with the next highest exception level, alongside the partition IDs for that exception level, it will be appreciated that these flags could also be stored in a separate control register.

More particularly, Table 3 lists the information included in each partition ID register 100, and Table 4 summarises which states each partition ID register 100 can be read or written from. Some of the registers 100 include information specific to that register as shown.

TABLE 3

| Which PARTID | | |
|---|---|---|
| register 100? | Field Name | Description |
| all | PARTID_I | Partition ID for instruction accesses |
| all | PARTID_D | Partition ID for data accesses |
| all | PMG | Performance monitoring group ID |
| MPAM1_EL1 | PLK_EL0 | PLK_EL0 locks the PARTID used at |
| | | NS_EL0 to be the same as the PARTID |
| | | used at NS_EL1. |
| MPAM1_ELI_S | PLK_EL0 | PLK_EL0 locks the PARTID used at |
| (optional - if not | | S_EL0 to be the same as the PARTID used |
| provided then | | at S_EL1. |
| PLK_EL0 in | | |
| MPAM1_EL1 | | |
| controls locking | | |
| of the PARTID | | |
| used at EL0 for | | |
| both the S and | | |
| NS states) | | |
| MPAM2_EL2 | EL1_WRINH | If 1, writes to MPAM1_EL1 from NS_EL1 |
| | | trap to NS_EL2. |
| MPAM3_EL3 | EL2_WRINH | If 1, writes to MPAM2_EL2 from NS_EL2 |
| | | trap to EL3. |
| MPAM3_EL3 | EL1_S_WRINH | If 1, writes to MPAM1_EL1_S from |
| | (optional - | S_EL1 are trapped to EL3. |
| | provided if | |
| | MPAM1_EL1_S | |
| | is provided) | |

TABLE 4

| PARTID | | | | | |
|---|---|---|---|---|---|
| register 100 | EL0 | NS_EL1 | S_EL1 | EL2 | EL3 |
| MPAM0_EL1 | R | RW | RW | RW | RW |
| MPAM1_EL1 | — | R(W*) | — | RW | RW |
| MPAM2_EL2 | — | — | — | R(W*) | RW |
| MPAM3_EL3 | — | — | — | — | RW |
| MPAM1_EL1_S | — | — | R(W*) | — | RW |

Where the asterisks indicate that:
MPAM1_EL1 can be written from NS_EL1 when EL1_WRINH in MPAM2_EL2=0, but when EL1_WRINH=1 then writes to MPAM1_EL1 from NS_EL1 trap to EL2;
MPAM2_EL2 can be written from EL2 when EL2_WRINH in MPAM3_EL3=0, but when EL2_WRINH=0 then writes to MPAM2_EL2 from EL2 trap to EL3;
MPAM1_EL1_S can be written from S_EL1 when EL1_S_WRINH in MPAM3_EL3=0, but when EL1_S_WRINH=1 then writes to MPAM1_EL1_S from S_EL1 trap to EL3.
   Hence, an attempt to set the partition ID register 100 from within the same exception state when not allowed by a higher exception state causes an exception event which triggers a switch to that higher exception state. An exception handler at the higher exception state can then decide how the partition ID should be set.

Note that in the alternative embodiment described above where MPAM_EL1_S is omitted, MPAM1_EL1 would be R(W*) accessible from both NS_EL1 and S_EL1 (with EL1_WRINH controlling whether write access is possible from EL1), and the EL1_S_WRINH configuration parameter can be omitted from register MPAM3_EL3.

In general, when a memory transaction is generated by the processing circuitry 6, one of the partition ID registers 100 is selected based on the current operating state as specified above. If the memory transaction is for accessing an instruction, the transaction is tagged with a partition ID derived from the PARTID_I field of the selected partition ID register. Page table walk memory transactions triggered by a miss in the TLB 72 for an instruction access would use the same partition ID as the instruction access. If the memory transaction is for accessing data, then the transaction is tagged with a partition ID derived from the PARTID_D field of the selected partition ID register 100 (and again any page table walk access triggered by the MMU following a data access would use the same partition ID as the data access itself). Note that regardless of whether the MMU issuing a page table walk access itself supports resource/performance monitoring partitioning based on the partition ID, it may still append the relevant PARTID_D or PARTID_I identifier to the corresponding memory transaction to allow memory system components in another part of the memory system to perform such partitioning. The PARTID_D and PARTID_I fields of a given partition ID register may be set to the same partition ID or to different partition IDs.

It can be useful to allow separate partition IDs to be defined for the data and instruction accesses for the same software execution environment, so that different resource control parameters can be used for the corresponding instruction and data accesses. An alternative approach would be to have a single partition ID associated with a software execution environment as a whole, but to append an additional bit of 0 or 1 depending on whether the access is for instructions or data, and this would allow the memory system component to select different control parameters for the instruction and data accesses respectively. However, for a given number of sets of control parameters selected based on the partition ID, this approach would mean that there would have to be a 50-50 split of the partition ID space between data and instructions. In practice, it may often be desirable to have more data partitions than instruction partitions, because it can be relatively common for multiple software execution environments to use the same code but execute with different data inputs, and so it can be particularly useful to be able to share a single instruction partition ID among multiple software execution environments while allowing each of those environments to use different data partitions. The approach of appending a 0 or 1 bit to indicate instruction on data accesses would in that circumstance require multiple sets of identical configuration information to be defined at the memory system component for each separate instance of the common code. In contrast, by providing separate instruction and data partition fields in the partition ID register 100, where the instruction and data partition IDs are selected from a common ID space, it is possible to reuse the same partition ID between different software execution environments and to partition the partition ID space between data and instructions as required without constraining this to a fifty-fifty split. Even though some additional storage capacity may be required for two partition ID fields in each partition ID register 100, this approach can save resource at the memory system component since by sharing one partition between the instruction accesses of multiple execution environments, fewer sets of control parameters (and hence less storage) are required at the memory system component.

Regardless of whether the transaction is for an instruction or data access, the transaction is also tagged with a performance monitoring partition ID derived from the PMG field of the selected partition ID register 100. This enables memory system components to partition performance monitoring, e.g. by using the performance monitoring ID of the memory transaction as part of the criteria for determining whether a given performance monitor should be updated in response to the memory transaction. In one embodiment, the PMG field may be treated as completely independent of the PARTID_D and PARTID_I fields. In this case, memory system components implementing performance monitoring may determine whether a memory transaction causes an update of a given performance monitor in dependence on the performance monitoring partition ID only, independent of the data/instruction partition ID included in the same memory transaction. This would provide the advantage that different partitions for instruction/data accesses could nevertheless share the same performance monitoring ID, which would support gathering of combined performance statistics for a number of processes which require different instruction/data access configurations at a memory system component. Hence, by specifying a performance monitoring group ID separate from the partition IDs used for controlling resource allocation at the memory system component, this allows multiple different software execution environments to be tracked using a common set of performance counters even if their resources are being allocated separately.

Alternatively, another approach may be to interpret the PMG field as a suffix to be appended to the corresponding partition ID derived from the PARTID_D or PARTID_I fields. With this approach, when a transaction is issued to memory, the transaction is appended with two IDs, one based on the selected PARTID_I or PARTID_D fields, and another based on the PMG field, but the PMG field is regarded as a property of the instruction/data partition ID rather than an ID in its own right. Hence, memory system components can in this case perform resource partitioning based on a first partition ID derived from PARTID_I or PARTID_D, but perform performance monitoring partitioning based on the combination of the first partition ID and a second partition ID derived from PMG. With this approach, it is no longer possible for different instruction/data partition IDs to share the same performance monitoring ID, but the advantage is that a shorter PMG field can be used to save hardware cost as the PMG field does not need to distinguish all possible performance monitoring partitions-only the partitions that share the same instruction/data partition ID are distinguished by the PMG field. For example, this can allow a 1 or 2-bit PMG field to be used rather than a larger field, which saves cost not only in the control registers 68 but also in the wires which carry the memory transactions through the memory system. In some embodiments, separate PMG suffix fields PMG_D and PMG_I could be provided corresponding to the PARTID_D and PARTID_I fields respectively, to allow separate performance monitoring group properties to be defined for data and instruction accesses respectively.

Either way, the ability to define multiple performance monitoring partitions per data/instruction partition ID can be useful. On the other hand, it will be appreciated that other examples could omit the separate performance monitoring ID field altogether, and instead use the same partition ID to control both the management of resources and the performance monitoring.

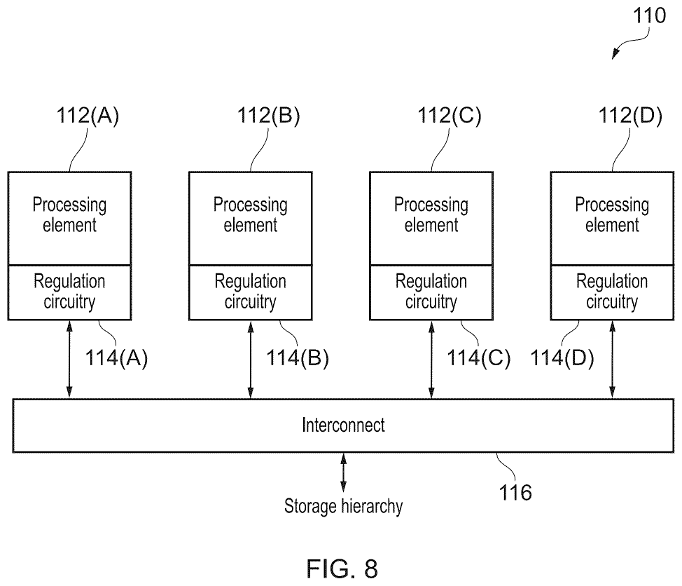

FIG. 8 schematically illustrates an apparatus 110 according to some configurations of the present technique. The apparatus 110 comprises a plurality of processing elements 112 and a plurality of sets of regulation circuitry 114. The processing elements 112 and the regulation circuitry 114 are connected to one another, and to a storage hierarchy, via an interconnect 116. In the illustrated configuration, the processing elements 112 comprise a first processing element 112(A) coupled to first regulation circuitry 114(A), a second processing element 112(B) coupled to second regulation circuitry 114(B), a third processing element 112(C) coupled to third regulation circuitry 114(C), and a fourth processing element 112(D) coupled to fourth regulation circuitry 114(D). It will be readily apparent to the skilled person that the regulation circuits 114 may alternately be provided as a single regulation circuit, for example comprised in the interconnect 116. The regulation circuits 114 are each responsive to feedback signals, received via the interconnect, to perform and modify control to restrict bandwidth utilisation associated with identifiers (e.g., partition identifiers) assigned to processes operating on the processing elements 112.

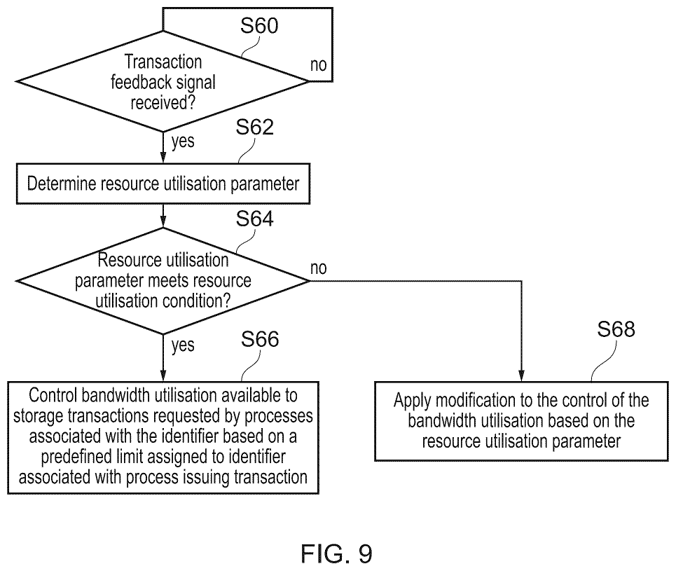

In particular, at least one of the instances of the regulation circuitry illustrated in FIG. 8 is arranged, in some configurations, to perform the sequence of steps illustrated in FIG. 9. Flow begins at step S60 where it is determined whether a transaction feedback signal is received by the regulation circuitry. If, at step S60, it is determined that no feedback signal has been received, then flow remains at step S60. If, at step S60, it is determined that the transaction feedback signal has been received, then flow proceeds to step S62 where the resource utilisation parameter is determined from the feedback signal. Flow then proceeds to step S64, where it is determined if the resource utilisation parameter meets a resource utilisation condition. If, at step S64, it is determined that the resource utilisation parameter meets the resource utilisation condition, then flow proceeds to step S66 where bandwidth utilisation available to storage transactions requested by processes associated with the identifier is controlled based on a predefined limit assigned to the identifier associated with the process issuing the transaction. If, at step S64, it is determined that the resource utilisation parameter does not meet the resource utilisation condition, then flow proceeds to step S68 where a modification is applied to the control of the bandwidth utilisation based on the resource utilisation parameter.

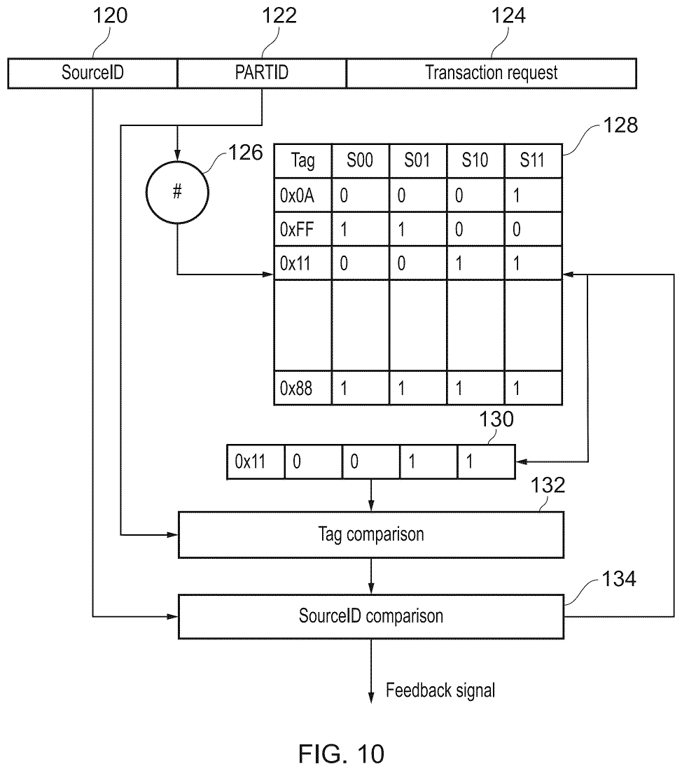

FIG. 10 schematically illustrates storage of information indicative of processes requesting bandwidth utilisation, for example, by the interconnect, according to some configurations of the present technique. In the illustrated configuration, the resource utilisation parameter included in the feedback signal provides an indication of the number of processing elements that are running processes associated with an identifier. This information may be used by the processing element, when operating in the at least one mode, to determine the control applied by the regulation circuitry. The information indicative of the processes requesting bandwidth utilisation is stored in a storage table 128 which is updated in response to a transaction request 124 received from one of the processing elements. The transaction request is associated with a source identifier (SourceID) 120 indicative of the processing element that issued the transaction request 124, and a partition identifier (PARTID) 124 which is the identifier associated with the process that issued the transaction request 124. The storage table 128 is indexed based on the partition identifier 124 using hash circuitry 126. The hash circuitry 122 receives at least part of the partition identifier 124 and generates a hashed value which identifies a row within the storage table 128. The identified row 130 is read out of the storage table 128 and the partition identifier 122 is compared against the full partition identifier stored in the tag field of the storage table 128 by tag comparison circuitry 132. If the tag comparison circuitry 132 determines that the partition identifier 122 matches the tag field of the identified row 130, then the remaining fields of the identified row 130 are passed to the sourceID comparison circuitry 134. In the illustrated configuration the storage table 128 comprises a column for each processing element connected to the interconnect with the value in that column indicative of whether the processing element corresponding to that column has been identified as issuing transactions associated with the partition identifier stored in the tag field for that row. In the illustrated example, it can be seen that the processing elements corresponding to sourceID S10 and sourceID S11 have each been identified as issuing transactions associated with the partition identifier 0x11. The sourceID comparison circuitry 134 determines, whether the sourceID 120 associated with the transaction request is already indicated in the storage table 128 as having issued one or more transaction requests associated with the PARTID 122. If, so, the sourceID comparison circuitry 134 transmits the feedback signal to the processing element having the sourceID 120 indicating the number of processing elements that are running processes associated with the identifier, i.e., an indication of the source identifiers set in the columns S00 to S11. Where the sourceID 120 is not already set in the storage identified entry 130 of the storage table 128, the sourceID comparison circuitry 134 sets that source identifier and stores the modified entry in the storage table 128.

Where the tag comparison circuitry 132 identifies that the tag does not match the partition identifier 122, the tag comparison circuitry may trigger an allocation of a new entry having the partition identifier as the tag based on an allocation policy. It will be readily apparent that, whilst in the illustrated configuration an indexed storage structure is used, a set associative or a fully associative storage structure could alternatively be used to store information indicative of the processing elements that are issuing transaction requests having a give processing identifier. In some configurations, the information in the storage table 128 is recorded over a window and may be marked as invalid (or otherwise reset) at the beginning of a window.

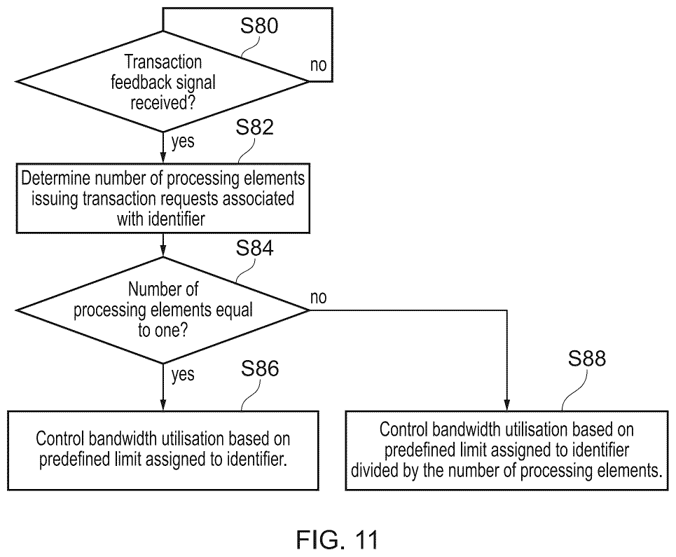

FIG. 11 schematically illustrates a sequence of steps carried out by regulation circuitry in response to the feedback signal issued in accordance with the circuit schematically illustrated in FIG. 10. Flow begins at step S80 where it is determined if a transaction feedback signal has been received. If, at step S80, it is determined that no transaction feedback signal has been received, then flow remains at step S80. If, at step S80, it is determined that a transaction feedback signal has been received, then flow proceeds to step S82, where the regulation circuitry determines the number of processing elements that are issuing transaction requests associated with the identifier. Flow then proceeds to step S84 where it is determined if the number of processing elements is equal to one. If, at step S84, it is determined that the number of processing elements is equal to one, then flow proceeds to step S86 where the bandwidth utilisation (e.g., the transaction rate) is limited based on the predefined limit assigned to the identifier. If, at step S84, it was determined that the number of processing elements is not equal to one, then flow proceeds to step S88 where the bandwidth utilisation is controlled based on the predefined limit assigned to the identifier divided by the number of processing elements as determined in step S82.

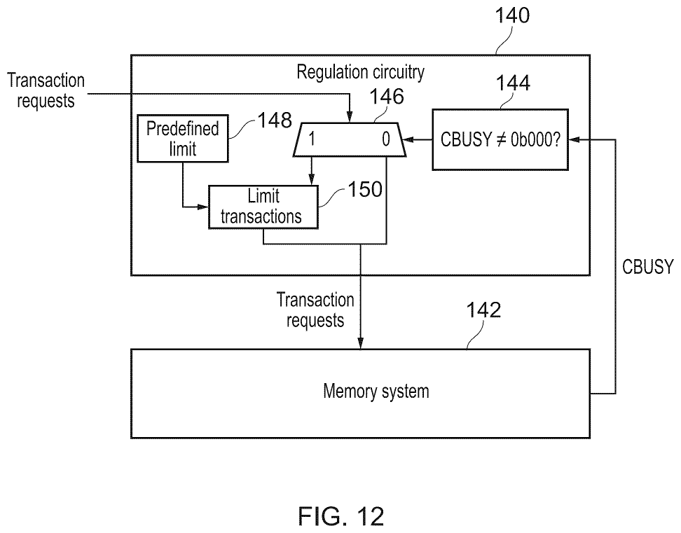

FIG. 12 schematically illustrates an interaction between regulation circuitry 140 and a memory system 142 according to some configurations of the present techniques. The regulation circuitry is provided with storage circuitry 148 to store an indication of the predefined limit, switch circuitry 146, transaction limitation circuitry 150, and comparison circuitry 144. The regulation circuitry 140 receives transaction requests and passes them onto the memory system 142 in dependence on the CBUSY signal which is received by the regulation circuitry 140 from the memory system 142. The CBUSY signal is a feedback signal indicative of whether the memory system which indicates how busy the completer is. In some configurations the CBUSY signal is a three-bit field indicating whether the completer is highly congested, lightly congested, or not congested. The CBUSY signal is passed to the comparator circuitry 144 which determines whether the CBUSY signal is or is not equal to 0b000, i.e., whether the CBUSY signal indicates that the memory system is not congested. The comparator circuitry 144 outputs a logical 0 (indicating that the resource utilisation condition is not satisfied) when the completer is not congested and a logical 1 (indicating that the resource utilisation is satisfied) otherwise. The output of the comparator circuitry is passed to switch circuitry 146 to control whether the output of the switch circuitry 146 is passed to the memory system without being limited based on the predefined limit or whether the output of the switch circuitry 146 is passed to the transaction limiting circuitry 150 to limit the bandwidth utilisation based on the predefined limit. The switch circuitry 146 receives the transaction requests and outputs them to the memory system when the output of the comparator circuitry 144 is a logical zero and outputs them to the limitation circuitry when the output of the comparator circuitry 144 is a logical 1. The limitation circuitry 150 is responsive to receipt of one or more transactions to determine whether the transaction will exceed the predefined limit 148. If the limit will be exceeded, then the transaction limitation circuitry 150 takes one or more steps to restrict the transaction (e.g., by stalling the requesting processing element). If the limit will not be exceeded, then the transaction limitation circuitry 150 passes the transaction request to the memory system 142 which takes steps to fulfil the transaction request.

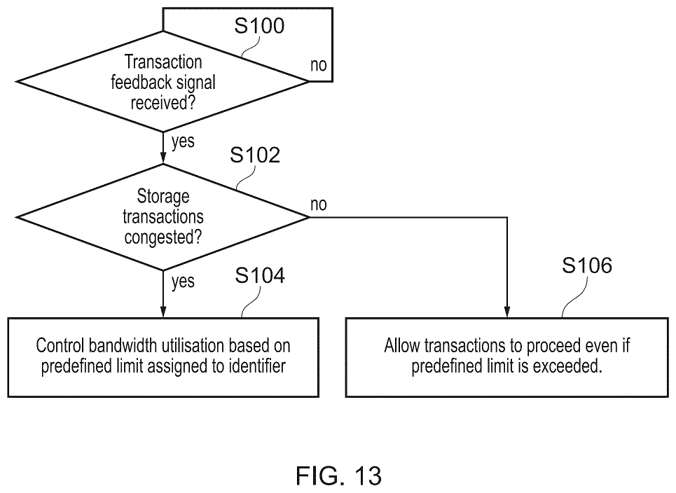

FIG. 13 schematically illustrates a sequence of steps carried out by regulation circuitry in response to the feedback signal issued in accordance with the circuit schematically illustrated in FIG. 12. Flow begins at step S100 where it is determined if the transaction feedback signal (e.g., the CBUSY signal) has been received. If, at step S100, it is determined that no transaction feedback signal has been received, then flow remains at step S100. If, at step S100, it is determined that a transaction feedback signal has been received, then flow proceeds to step S102. At step S102, it is determined if the storage transactions are congested (e.g., if CBUSY is not equal to 0b000). If, at step S102, it is determined that the storage transactions are congested, then flow proceeds to step S104 where the regulation circuitry controls bandwidth utilisation based on a predefined limit assigned to the identifier. If, at step S102, it is determined that the storage transactions are not congested (e.g., if CBUSY is equal to 0b000), then flow proceeds to step S106 where transactions are allowed to proceed even if the predefined limit is exceeded.

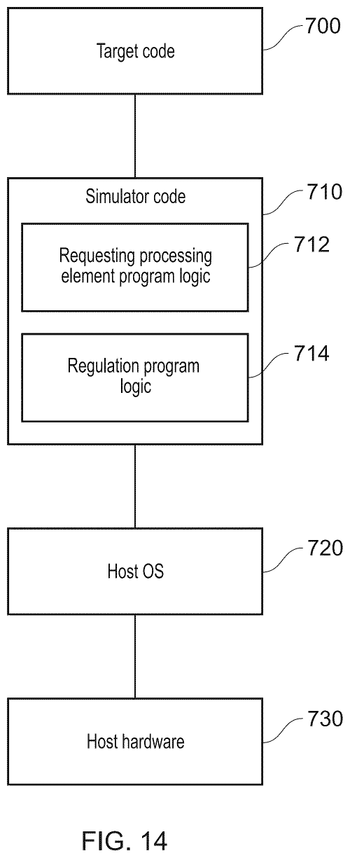

FIG. 14 schematically illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 730, optionally running a host operating system 720, supporting the simulator program 710. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 730), some simulated embodiments may make use of the host hardware, where suitable.

The simulator program 710 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 710. Thus, the program instructions of the target code 700 may be executed from within the instruction execution environment using the simulator program 710, so that a host computer 730 which does not actually have the hardware features of the apparatuses described in relation to FIGS. 1 to 13 above. For example, the simulator code 710 may comprise requesting processing element program logic 712 configured to issue a storage transaction in response to a storage access request from a process running on the requesting processing element program logic, the process associated with an identifier, and regulation program logic 714 configured to control a bandwidth utilisation available to storage transactions requested by processes associated with the identifier. When operating in at least one mode the regulation program logic is configured to control the bandwidth utilisation, based on a transaction feedback signal issued by program logic other than the requesting processing element program logic and indicative of a resource utilisation parameter: when the resource utilisation parameter satisfies a resource utilisation condition, to apply a control to restrict the bandwidth utilisation to a predefined limit assigned to the identifier; and when the resource utilisation parameter does not satisfy the resource utilisation condition, to apply a modification to the control based on the resource utilisation parameter.

In brief overall summary there is provided an apparatus, a method, and a computer program. The apparatus comprises a requesting processing element to issue a storage transaction in response to an access request from a process running on the requesting processing element, the process associated with an identifier. The apparatus is also provided with regulation circuitry to control bandwidth available to storage transactions requested by processes associated with the identifier. The regulation circuitry is configured to control the bandwidth, based on a transaction feedback signal issued by circuitry other than the requesting processing element and indicative of a resource utilisation parameter: when the resource utilisation parameter satisfies a resource utilisation condition, to apply a control to restrict the utilisation to a predefined limit assigned to the identifier; and when the resource utilisation parameter does not satisfy the resource utilisation condition, to apply a modification to the control based on the resource utilisation parameter.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
a requesting processing element configured to issue a storage transaction in response to a storage access request from a process running on the requesting processing element, the process associated with an identifier; and
regulation circuitry configured to control a bandwidth utilisation available to storage transactions requested by processes associated with the identifier, wherein when operating in at least one mode the regulation circuitry is configured to control the bandwidth utilisation, based on a transaction feedback signal issued by circuitry other than the requesting processing element and indicative of a resource utilisation parameter:
   when the resource utilisation parameter satisfies a resource utilisation condition, to apply a control to restrict the bandwidth utilisation to a predefined limit assigned to the identifier; and
   when the resource utilisation parameter does not satisfy the resource utilisation condition, to apply a modification to the control based on the resource utilisation parameter.

Clause 2. The apparatus of clause 1, wherein the resource utilisation parameter indicates utilisation of resources by processes associated with the identifier.

Clause 3. The apparatus of clause 1 or clause 2, wherein the resource utilisation parameter comprises an indication of utilisation of resources other than the requesting processing element.

Clause 4. The apparatus of any preceding clause, wherein the resource utilisation parameter comprises processing element identifying information indicative of processing elements running processes associated with the identifier, and the resource utilisation condition comprises a processing element condition satisfied when the requesting processing element is the only processing element identified as running processes associated with the identifier.

Clause 5. The apparatus of clause 4, wherein the processing element identifying information indicates a number of processing elements running processes associated with the identifier, and the modification comprises restricting the bandwidth utilisation to a reduced limit based on the number of processing elements.

Clause 6. The apparatus of clause 5, wherein the reduced limit is calculated by dividing the bandwidth utilisation limit by the number of processing elements running processes associated with the identifier.

Clause 7. The apparatus of any of clause 4 to clause 6, comprising interconnect circuitry configured to store processing element utilisation information indicative of a number of processing elements issuing transaction requests associated with the identifier, wherein the interconnect is configured to issue the feedback signal indicating the number of processing elements.

Clause 8. The apparatus of clause 7, wherein the interconnect is configured to apply an aging mechanism to the processing element utilisation information.

Clause 9. The apparatus of clause 8, wherein the aging mechanism comprises storing the processing element utilisation information over a sliding window.

Clause 10. The apparatus of any preceding clause, wherein the resource utilisation parameter comprises a congestion parameter indicative of congestion of storage requests and the resource utilisation condition comprises a congestion condition satisfied when the congestion parameter exceeds a congestion threshold.

Clause 11. The apparatus of clause 10, wherein the restriction circuitry is configured, when applying the modification, to allow the processing element to issue requests at a rate greater than the predefined limit.

Clause 12. The apparatus of clause 10 or clause 11, wherein the restriction circuitry is configured, when applying the modification, to apply a soft limit to the bandwidth utilisation, the soft limit allowing the bandwidth utilisation to exceed the predefined limit.

Clause 13. The apparatus of any of clauses 10 to 12, wherein the utilisation parameter is issued by a storage hierarchy.

Clause 14. The apparatus of any preceding clause, comprising one or more software accessible registers, wherein the predefined limit is stored in the one or more registers.

Clause 15. The apparatus of any preceding clause, wherein the identifier is one of a plurality of identifiers, each assignable to one or more processes and the predefined limit is set on a per identifier basis.

Clause 16. The apparatus of any preceding clause, wherein the requesting processing element is operable in a further mode in which the regulation circuitry is configured to restrict the bandwidth utilisation to the predefined limit independent of the transaction feedback signal.

Clause 17. The apparatus of any preceding clause, wherein the requesting processing element is configured to stall execution of the process in response to the one or more limits being met.

Clause 18. The apparatus of any preceding clause, wherein the identifier associated with the process is defined in a software-configurable register.

Clause 19. A method comprising:
with a requesting processing element, issuing a storage transaction in response to a storage access request from a process running on the requesting processing element, the process associated with an identifier; and
controlling a bandwidth utilisation available to storage transactions requested by processes associated with the identifier, wherein when operating in at least one mode the regulation comprises controlling the bandwidth utilisation, based on a transaction feedback signal issued by circuitry other than the requesting processing element and indicative of a resource utilisation parameter:
   when the resource utilisation parameter satisfies a resource utilisation condition, to apply a control to restrict the bandwidth utilisation to a predefined limit assigned to the identifier; and
   when the resource utilisation parameter does not satisfy the resource utilisation condition, to apply a modification to the control based on the resource utilisation parameter.

Clause 20. A computer program for controlling a host data processing apparatus to provide an instruction execution environment, the computer program comprising:
requesting processing element program logic configured to issue a storage transaction in response to a storage access request from a process running on the requesting processing element program logic, the process associated with an identifier; and
regulation program logic configured to control a bandwidth utilisation available to storage transactions requested by processes associated with the identifier, wherein when operating in at least one mode the regulation program logic is configured to control the bandwidth utilisation, based on a transaction feedback signal issued by program logic other than the requesting processing element program logic and indicative of a resource utilisation parameter:
   when the resource utilisation parameter satisfies a resource utilisation condition, to apply a control to restrict the bandwidth utilisation to a predefined limit assigned to the identifier; and
   when the resource utilisation parameter does not satisfy the resource utilisation condition, to apply a modification to the control based on the resource utilisation parameter.

We claim:

1. An apparatus comprising:
a requesting processing element configured to issue a storage transaction in response to a storage access request from a process running on the requesting processing element, the process associated with an identifier; and
regulation circuitry configured to control a bandwidth utilisation available to storage transactions requested by processes associated with the identifier, wherein when operating in at least one mode the regulation circuitry is configured to control the bandwidth utilisation, based on a transaction feedback signal issued by circuitry other than the requesting processing element and indicative of a resource utilisation parameter:
when the resource utilisation parameter satisfies a resource utilisation condition, to apply a control to restrict the bandwidth utilisation to a predefined limit assigned to the identifier; and
when the resource utilisation parameter does not satisfy the resource utilisation condition, to apply a modification to the control based on the resource utilisation parameter.

2. The apparatus of claim 1, wherein the resource utilisation parameter indicates utilisation of resources by processes associated with the identifier.

3. The apparatus of claim 1, wherein the resource utilisation parameter comprises an indication of utilisation of resources other than the requesting processing element.

4. The apparatus of claim 1, wherein the resource utilisation parameter comprises processing element identifying information indicative of processing elements running processes associated with the identifier, and the resource utilisation condition comprises a processing element condition satisfied when the requesting processing element is the only processing element identified as running processes associated with the identifier.

5. The apparatus of claim 4, wherein the processing element identifying information indicates a number of processing elements running processes associated with the identifier, and the modification comprises restricting the bandwidth utilisation to a reduced limit based on the number of processing elements.

6. The apparatus of claim 5, wherein the reduced limit is calculated by dividing the bandwidth utilisation limit by the number of processing elements running processes associated with the identifier.

7. The apparatus of claim 4, comprising interconnect circuitry configured to store processing element utilisation information indicative of a number of processing elements issuing transaction requests associated with the identifier, wherein the interconnect is configured to issue the feedback signal indicating the number of processing elements.

8. The apparatus of claim 7, wherein the interconnect is configured to apply an aging mechanism to the processing element utilisation information.

9. The apparatus of claim 8, wherein the aging mechanism comprises storing the processing element utilisation information over a sliding window.

10. The apparatus of claim 1, wherein the resource utilisation parameter comprises a congestion parameter indicative of congestion of storage requests and the resource utilisation condition comprises a congestion condition satisfied when the congestion parameter exceeds a congestion threshold.

11. The apparatus of claim 10, wherein the restriction circuitry is configured, when applying the modification, to allow the processing element to issue requests at a rate greater than the predefined limit.

12. The apparatus of claim 10, wherein the restriction circuitry is configured, when applying the modification, to apply a soft limit to the bandwidth utilisation, the soft limit allowing the bandwidth utilisation to exceed the predefined limit.

13. The apparatus of claim 10, wherein the utilisation parameter is issued by a storage hierarchy.

14. The apparatus of claim 1, comprising one or more software accessible registers, wherein the predefined limit is stored in the one or more registers.

15. The apparatus of claim 1, wherein the identifier is one of a plurality of identifiers, each assignable to one or more processes and the predefined limit is set on a per identifier basis.

16. The apparatus of claim 1, wherein the requesting processing element is operable in a further mode in which the regulation circuitry is configured to restrict the bandwidth utilisation to the predefined limit independent of the transaction feedback signal.

17. The apparatus of claim 1, wherein the requesting processing element is configured to stall execution of the process in response to the one or more limits being met.

18. The apparatus of claim 1, wherein the identifier associated with the process is defined in a software-configurable register.

19. A method comprising:
with a requesting processing element, issuing a storage transaction in response to a storage access request from a process running on the requesting processing element, the process associated with an identifier; and
controlling a bandwidth utilisation available to storage transactions requested by processes associated with the identifier, wherein when operating in at least one mode the regulation comprises controlling the bandwidth utilisation, based on a transaction feedback signal issued by circuitry other than the requesting processing element and indicative of a resource utilisation parameter:
when the resource utilisation parameter satisfies a resource utilisation condition, to apply a control to restrict the bandwidth utilisation to a predefined limit assigned to the identifier; and
when the resource utilisation parameter does not satisfy the resource utilisation condition, to apply a modification to the control based on the resource utilisation parameter.

20. A computer program for controlling a host data processing apparatus to provide an instruction execution environment, the computer program comprising:
requesting processing element program logic configured to issue a storage transaction in response to a storage access request from a process running on the requesting processing element program logic, the process associated with an identifier; and
regulation program logic configured to control a bandwidth utilisation available to storage transactions requested by processes associated with the identifier, wherein when operating in at least one mode the regulation program logic is configured to control the bandwidth utilisation, based on a transaction feedback signal issued by program logic other than the requesting processing element program logic and indicative of a resource utilisation parameter:
when the resource utilisation parameter satisfies a resource utilisation condition, to apply a control to restrict the bandwidth utilisation to a predefined limit assigned to the identifier; and
when the resource utilisation parameter does not satisfy the resource utilisation condition, to apply a modification to the control based on the resource utilisation parameter.
